(19) United States
(12) Patent Application Publication
(10) Pub. No.: US 2010/0060005 A1
(43) Pub. Date: Mar. 11, 2010

(54) Power generation system using low grade solar energy

(76) Inventors: Mohinder S. Bhatti, Williamsville, NY (US); Mingyu Wang, Amherst, NY (US)

Correspondence Address: Delphi Technologies, Inc., M/C 480-410-202, PO BOX 5052, Troy, MI, 48007, US

(21) Appl. No.: 12/231,824

(22) Filed: Sep. 5, 2008

(51) Int. Cl. F01D 15/10; F03G 6/00; F01K 11/02

(52) U.S. Cl. 290/52; 60/641.8; 60/670

(57) ABSTRACT

Disclosed is a system providing practical power generation from heat energy input from a low grade source, such as solar energy. In a modified Rankine cycle, increased energy is extracted via the turbine by letting the working fluid drop to a lower pressure. Phase change of the low pressure working fluid is accomplished using enhanced condensation. Condensation is enhanced by use of an evaporative cooler. To enable continued operation when solar exposure is attenuated, a supplemental heater is included to heat the working fluid.

### TECHNICAL FIELD

This invention relates generally to power generation and, more particularly, to generation of power using solar energy.

### BACKGROUND INFORMATION

In the conventional power generation system based on the Rankine cycle the boiler temperature is maintained as high as possible to achieve high power output from the turbine. This is possible since the heat source employed by the conventional power generation systems is a high grade thermal source, such as hydrocarbon fuels or nuclear fuel.

The Rankine cycle is a thermodynamic cycle which converts heat into work. The heat is supplied externally to a closed loop that typically uses water as the working fluid. Other working fluids that are used in some applications are sodium, pentane, and butane. Almost all coal and nuclear power stations use the Rankine cycle for power generation. Conventional steam power plants based on the Rankine cycle operate close to the critical temperature of water, which is 705° F.

When using a low grade thermal energy source, such as solar energy, one has no choice but to operate the system at relatively low temperature on the order of 200° F. This makes it challenging to obtain sufficient thermal energy for practical operation.

What is needed is a way to provide practical generation of energy via a Rankine cycle using a low grade thermal energy source.

### SUMMARY OF THE INVENTION

In general terms, this power generation system provides a heat engine that is useful to generate power using a low grade energy source, such as solar energy.

A commercially practical amount of power is output from a gas turbine when the working fluid is allowed to expand to a sufficiently low pressure at the turbine outlet. To accommodate this lower pressure, the working fluid is subjected to an enhanced condensing stage after substantial pressure drop in the turbine. The enhanced condensing is achieved by the use of an evaporative cooler to chill the condenser. This evaporative cooling feature is useful in both direct and indirect power generation systems.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 shows a pressure versus enthalpy diagram comparing a power cycle using enhanced condensing according to embodiments of the present invention with a power cycle utilizing conventional cooling.

FIG. 2 illustrates schematically a system for power generation according to one embodiment of the present invention with direct heating of the working fluid.

FIG. 3 illustrates schematically a system for power generation according to one embodiment of the present invention with indirect heating of the working fluid.

### DETAILED DESCRIPTION

The power generating system provides practical power generation from heat energy input from a low grade source, such as solar energy. In a modified Rankine cycle, increased energy is extracted via the turbine by letting the working fluid drop to a lower pressure at the turbine outlet. Phase change of the low pressure working fluid from gas to liquid is accomplished using enhanced condensation. Condensation is enhanced by use of an evaporative cooling loop.

The description that follows is made in terms of a water-steam working fluid for ease of understanding, since water-steam systems are the most common implementations of the Rankine cycle. However, the invention can readily be implemented using any suitable working fluid to fit applications where different temperature profiles are needed.

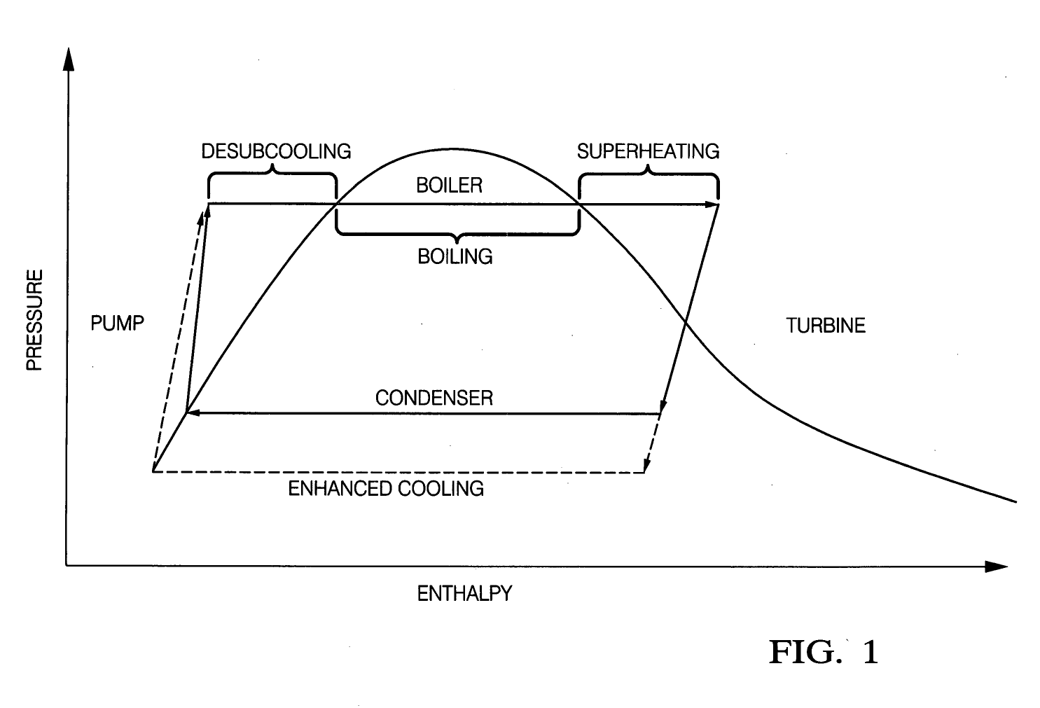

Referring to FIG. 1, a pressure versus enthalpy diagram describes a power cycle using enhanced condensing according to embodiments of the present invention compared with a power cycle utilizing conventional cooling. Heating of the working fluid occurs at a substantially constant pressure and traces a line of increasing enthalpy. The fluid receives heat energy by flowing through a solar collector.

The heated working fluid enters the turbine as superheated steam and flows through the turbine turning its blades and producing work, while at the same time suffering a loss in pressure. The process differs from a typical Rankine cycle process in that gas exiting from the turbine has a lower pressure as indicated by the broken line extending beyond the solid line of the pressure-enthalpy diagram through the turbine.

The working fluid then undergoes an enhanced condensing step that reduces enthalpy at a constant pressure, as shown by the broken line at the bottom of the power cycle curve. This is in contrast to the higher pressure condensing that would occur in a conventional system, as shown by the solid line above the broken enhanced condensing line. Condensation at the lower pressure cannot satisfactorily be achieved with conventional condensers. A condenser in combination with an evaporative cooling loop is used to provide an enhanced condensation.

The condensed working fluid is pumped at an increased pressure back into the inlet of the solar collector to receive heat input and begin the cycle again.

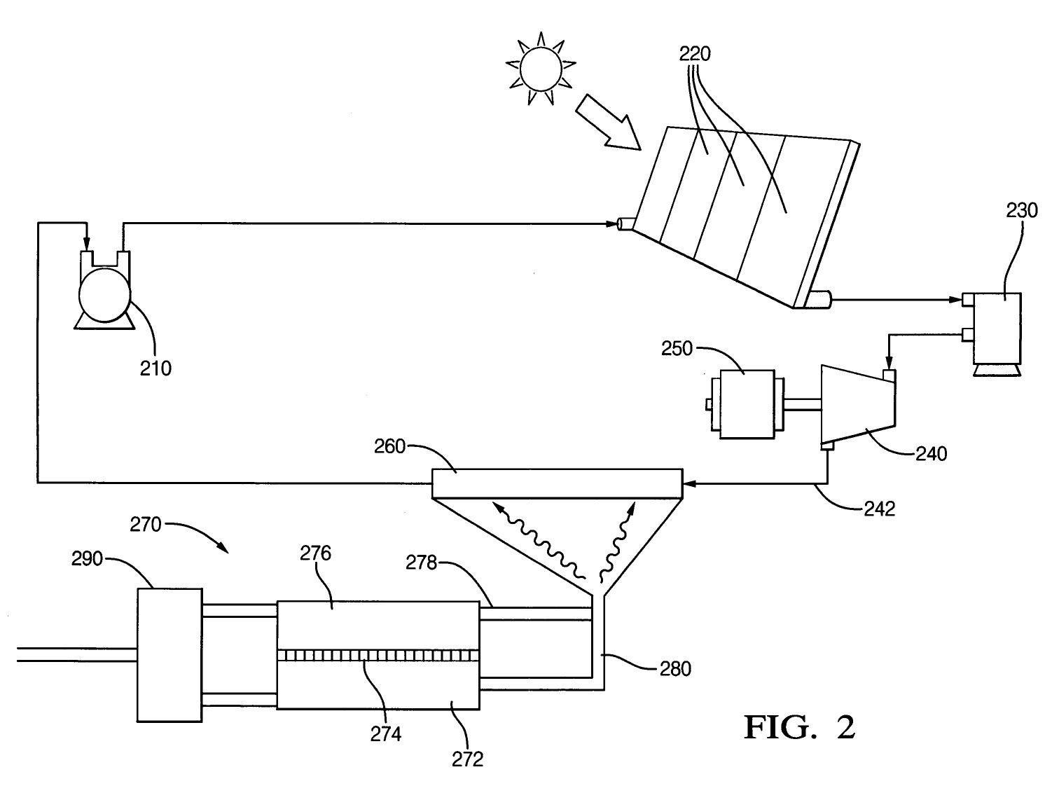

Referring to FIG. 2, a schematic diagram illustrates a system for power generation with direct heating of the working fluid that is subject to enhanced condensing. The working fluid is forced under pressure by a refrigerant pump 210 into a solar collector array 220 where it is heated by solar radiation to a superheated gas state. A gas-fired heater 230 is plumbed in series with the solar collector array 220 to provide thermal energy to the working fluid during periods of decreased sunlight. The heater 230 can alternatively be embodied as burning other fuels such as coal or oil. Operation of the supplemental heater 230 is controllable by modulating the amount of heating to provide consistent desired energy output. Optionally, the heater 230 may be omitted from the loop.

After heating (via the solar collector array 220, the heater 230, or both in combination), the working fluid enters a steam turbine 240 to perform work by driving the turbine to rotate so as to turn an electric generator 250. The work produced by the steam turbine 240 is maximized by permitting a low pressure for the working fluid at the turbine outlet 242.

Condensation of the low pressure working fluid emerging from the turbine outlet 242 is achieved via a condenser 260 that is augmented by an evaporative cooler 270 to provided enhanced condensing.

The evaporative cooler 270 forces ambient air through a proportioning valve 290 into a dry channel 272 and a wet channel 276. The wet channel 276 is lined internally with a wick medium 274 saturated with water (or other suitable working fluid). Heat removed from the air in the contiguous dry channel 272 causes evaporation of liquid water in the wick medium 274. Thus generated water vapor is carried away by the air stream 278 flowing through the wet channel 276. This wet air stream 278 could be exhausted into the atmosphere or it could be utilized for some other purpose such as for precooling the incoming ambient air into the proportioning valve 290. The cooler dry air stream 280 emerging from the dry channel 272 is utilized as the cooling fluid in the condenser 260 to condense the working fluid of the power cycle emerging as gas from the turbine outlet 242.

More thermal energy is removed from the working fluid of the power cycle in the condenser 260 when using dry conditioned air 280 than would be removed using only ambient air since the dry bulb temperature of the conditioned dry air 280 is lower than that of the ambient air.

The function of the proportioning valve 290 is to regulate the flow rates of ambient air through the dry channel 272 and the wet channel 276. The flow rates of ambient air going through the dry and wet channels are regulated based on the desired temperature of the conditioned air 280, which in turn is dictated by the desired temperature of the working fluid of the power cycle in the condenser 260. Thus the condenser operation is also controllable by the proportioning valve 290.

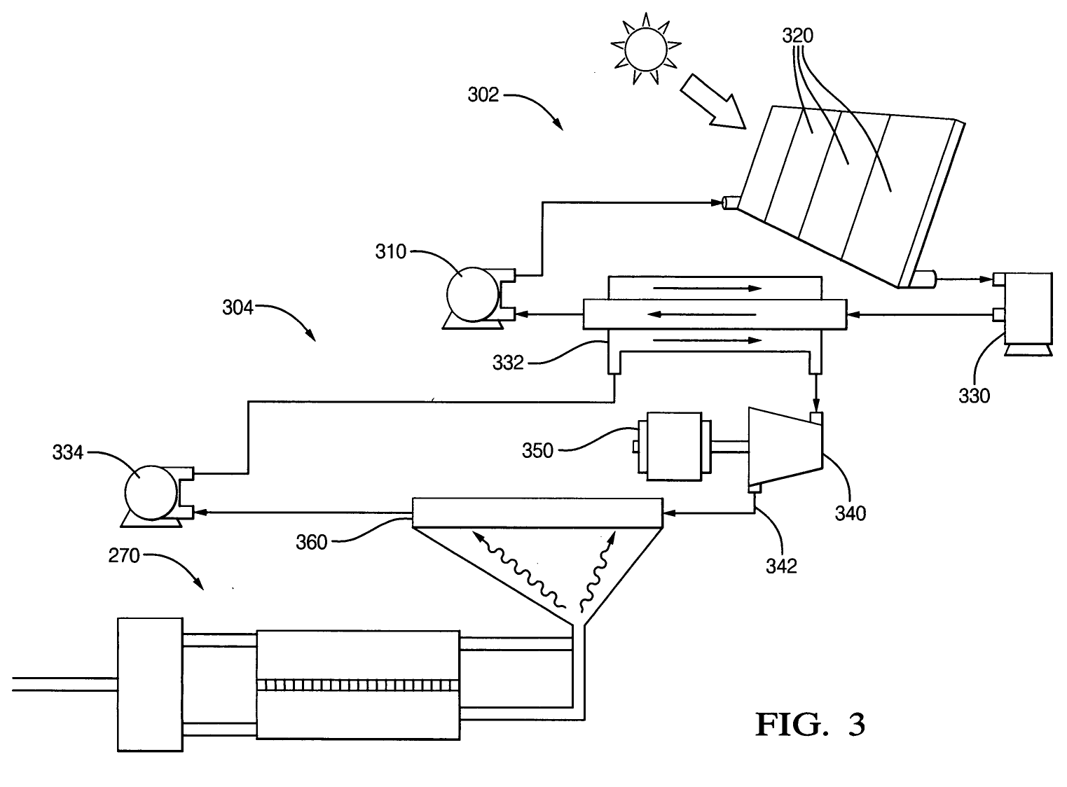

Referring to FIG. 3, a schematic diagram illustrates a system for power generation wherein the working fluid subject to enhanced condensing is heated indirectly via a heat exchanger. The working fluid in a secondary loop 302 is forced under pressure by a secondary refrigerant pump 310 into a solar collector array 320 where it is heated by solar radiation to a superheated gas state. A gas-fired heater 330 is plumbed in series with the solar collector array 320 to provide heat energy to the working fluid during periods of decreased sunlight. Operation of the supplemental heater 330 is controllable by modulating the amount of heating to provide consistent output power. Optionally, the heater 330 can be omitted from the loop.

After heating (via the solar collector array 320, the heater 330, or both in combination), the secondary loop working fluid enters a secondary loop heat exchanger 332 that transfers thermal energy from the secondary loop 302 to the primary loop 304 of the system.

Working fluid in the primary loop 304 is circulated by a primary loop refrigerant pump 334 that forces working fluid through one side of the secondary loop heat exchanger 332. After receiving heat transferred via the heat exchanger 332, the evaporated working fluid in the secondary loop enters a turbine 340 to perform work by driving the turbine to rotate about a shaft that turns an electric generator 350. The work produced by the turbine 340 is maximized by permitting a low pressure for the working fluid at the turbine outlet 342.

Condensation of the low pressure working fluid emerging from the gas outlet 342 is achieved via a condenser 360 that is augmented by an evaporative cooler 270 to provide enhanced condensing. The structure and operation of the evaporative cooler is analogous to that described with respect to FIG. 2.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A direct power generation system comprising:
a pump having an pump input and a pump output;
a solar collector having a collector input and a collector output, the collector input being in fluid communication with the pump output to receive pressurized working fluid from the pump;
a turbine having a turbine input and a turbine output, the turbine input being in fluid communication with the collector output to receive evaporated working fluid from the collector;
a generator in mechanical communication with the turbine so as to generate electricity in response to rotational force provided by the turbine;
a condenser having a condenser input and a condenser output, the condenser input being in fluid communication with the turbine output to receive working fluid from the turbine, and the condenser output being in fluid communication with the pump input to provide condensed working fluid to the pump;
an evaporative cooler disposed in thermal communication with the condenser so as to cool the condenser with humid air that has been cooled by evaporative cooling.

2. A direct power generation system comprising:
a pump having an pump input and a pump output;
a solar collector having a collector input and a collector output, the collector input being in fluid communication with the pump output to receive pressurized working fluid from the pump;
a heater having a heater input and a heater output, the heater input being in fluid communication with the collector output to receive working fluid from the collector;
a turbine having a turbine input and a turbine output, the turbine input being in fluid communication with the heater output to receive evaporated working fluid from the heater;
a generator in mechanical communication with the turbine so as to generate electricity in response to rotational force provided by the turbine;
a condenser having a condenser input and a condenser output, the condenser input being in fluid communication with the turbine output to receive working fluid from the turbine, and the condenser output being in fluid communication with the pump input to provide condensed working fluid to the pump;
an evaporative cooler disposed in thermal communication with the condenser so as to cool the condenser with humid air that has been cooled by evaporative cooling.

3. An indirect power generation system comprising:
a primary loop pump having an primary loop pump input and a primary loop pump output;
a heat exchanger having a primary exchanger input, a primary exchanger output, a secondary exchanger input and a secondary exchanger output, the primary exchanger input being in fluid communication the primary loop pump output to receive pressurized working fluid from the primary loop pump;
a turbine having a turbine input and a turbine output, the turbine input being in fluid communication with the secondary exchanger output to receive evaporated working fluid from the heat exchanger;
a generator in mechanical communication with the turbine so as to generate electricity in response to rotational force provided by the turbine;
a condenser having a condenser input and a condenser output, the condenser input being in fluid communication with the turbine output to receive working fluid from the turbine, and the condenser output being in fluid communication with the primary loop pump input to provide condensed working fluid to the primary loop pump;
a secondary loop pump having an secondary loop pump input and a secondary loop pump output;
a solar collector having a collector input and a collector output, the collector input being in fluid communication with the secondary loop pump output to receive pressurized working fluid from the secondary loop pump, the secondary exchanger input being in fluid communication with the collector output to receive evaporated working fluid from the collector, and the secondary exchanger output being in fluid communication with the secondary loop pump input to provide condensed working fluid to the secondary loop pump; and
an evaporative cooler disposed in thermal communication with the condenser so as to cool the condenser with humid air that has been cooled by evaporative cooling.

4. An indirect power generation system comprising:
a primary loop pump having an primary loop pump input and a primary loop pump output;
a heat exchanger having a primary exchanger input, a primary exchanger output, a secondary exchanger input and a secondary exchanger output, the primary exchanger input being in fluid communication the primary loop pump output to receive pressurized working fluid from the primary loop pump;
a turbine having a turbine input and a turbine output, the turbine input being in fluid communication with the secondary exchanger output to receive evaporated working fluid from the heat exchanger;
a generator in mechanical communication with the turbine so as to generate electricity in response to rotational force provided by the turbine;
a condenser having a condenser input and a condenser output, the condenser input being in fluid communication with the turbine output to receive working fluid from the turbine, and the condenser output being in fluid communication with the primary loop pump input to provide condensed working fluid to the primary loop pump;
a secondary loop pump having an secondary loop pump input and a secondary loop pump output;
a solar collector having a collector input and a collector output, the collector input being in fluid communication with the secondary loop pump output to receive pressurized working fluid from the secondary loop pump;
a heater having a heater input and a heater output, the heater input being in fluid communication with the collector output to receive working fluid from the collector, the secondary exchanger input being in fluid communication with the heater output to receive evaporated working fluid from the heater, and the secondary exchanger output being in fluid communication with the secondary loop pump input to provide condensed working fluid to the secondary loop pump; and;
an evaporative cooler disposed in thermal communication with the condenser so as to cool the condenser with humid air that has been cooled by evaporative cooling.
